(19) United States
(12) Patent Application Publication
(10) Pub. No.: US 2021/0012143 A1
(43) Pub. Date: Jan. 14, 2021

(54) Key Point Detection Method and Apparatus, and Storage Medium

(71) Applicant: Zhejiang SenseTime Technology Development Co., Ltd., Hangzhou (CN)

(72) Inventors: Hujun Bao, Hangzhou (CN); Xiaowei Zhou, Hangzhou (CN); Sida Peng, Hangzhou (CN); Yuan Liu, Hangzhou (CN)

(73) Assignee: Zhejiang SenseTime Technology Development Co., Ltd., Hangzhou (CN)

(21) Appl. No.: 17/038,000

(22) Filed: Sep. 30, 2020

Related U.S. Application Data
(63) Continuation of application No. PCT/CN2019/122112, filed on Nov. 29, 2019.

(30) Foreign Application Priority Data
Dec. 25, 2018 (CN) 201811593614.X

(51) Int. Cl. G06K 9/46; G06T 7/70; G06T 5/30; G06N 3/08

(52) U.S. Cl. CPC G06K 9/4671; G06T 7/70; G06T 2207/20081; G06N 3/08; G06T 2207/20084; G06T 5/30

(57) ABSTRACT

The present disclosure relates to a key point detection method and apparatus, an electronic device and a storage medium. The method comprises: determining an area in which a plurality of pixels of an image to be processed are located and first direction vectors of the plurality of pixels pointing to a key point of the area; and determining the position of the key point in the area based on the area in which the pixels are located and the first direction vectors of the plurality of pixels in the area.

### CROSS-REFERENCE TO RELATED APPLICATION

The present disclosure is a continuation of and claims priority under 35 U.S.C. § 120 to PCT Application. No. PCT/CN2019/122112, filed on Nov. 29, 2019, which claims the priority to Chinese Patent Application No. 201811593614.X filed with National Intellectual Property Administration, PRC, on Dec. 25, 2018, entitled “Key Point Detection Method and Apparatus, Electronic Device and Storage Medium”. All the above referenced priority documents are incorporated herein by reference in its entirety.

### TECHNICAL FIELD

The present disclosure relates to the field of computer technology, and in particular to a key point detection method and apparatus, an electronic device and a storage medium.

### BACKGROUND OF THE INVENTION

In related technologies, multiple targets such as human faces, objects, and scenes may appear in one frame of an image. The multiple targets shown may overlap, block or interfere with each other in the image, resulting in inaccurate detection for a key point of the image. In addition, the target may be blocked or fall out of the image capturing range, that is, a part of the target is not captured, and this may also result in low robustness of key point detection and inaccurate detection for target points.

### SUMMARY OF THE INVENTION

The present disclosure provides a key point detection method and apparatus, an electronic device and a storage medium.

According to an aspect of the present disclosure, a key point detection method is provided, comprising:

determining an area in which a plurality of pixels of an image to be processed are located and first direction vectors of the plurality of pixels pointing to a key point of the area, wherein the image to be processed comprises one or more areas; and determining the position of the key point in the area based on the area in which the pixels are located and the first direction vectors of the plurality of pixels in the area.

According to the key point detection method in the embodiments of the present disclosure, the area in which the plurality of pixels are located and the first direction vectors of the plurality of pixels pointing to the key point of the area may be obtained, and the position of the key point in the area may be determined according to the first direction vectors. Thus, the situation where the target area is blocked or falls out of the image capturing range may be avoided, the robustness of key point detection is improved, and the accuracy of detection is increased.

In a possible implementation, the determining the position of the key point in the area based on the area in which the pixels are located and the first direction vectors of the plurality of pixels in the area comprises:

determining estimated coordinates of the key point in a target area and weights of the estimated coordinates of the key point based on the area in which the pixels are located and the first direction vectors, wherein the target area is any one of the one or more areas; and

performing weighted averaging on the estimated coordinates of the key point in the target area based on the weights of the estimated coordinates of the key point, to obtain the position of the key point in the target area.

In this way, the estimated coordinates of key point in the target area may be detected, and the estimated coordinates of the key point may be determined for each target area, which reduces interferences between different areas and improves the accuracy of key point detection. Furthermore, the estimated coordinates of the key point may be determined by the second direction vectors. The weights of the estimated coordinates of the key point may be determined by the inner products of the first direction vectors and the second direction vectors. The probability distribution of the position of the key point may also be obtained by performing weighted averaging on the estimated coordinates of the key point to obtain the position of the key point, which improves the accuracy in determining the position of the key point.

In a possible implementation, the determining the estimated coordinates of the key point in the target area and the weights of the estimated coordinates of the key point based on the area in which the pixels are located and the first direction vectors comprises: screening the plurality of pixels of the image to be processed based on the area in which the pixels are located, to determine a plurality of target pixels falling within the target area;

determining coordinates of the intersection of the first direction vectors of any two target pixels as the estimated coordinates of the key point; and determining the weights of the estimated coordinates of the key point based on the estimated coordinates of the key point and the pixels in the target area.

In a possible implementation, the determining the weights of the estimated coordinates of the key point based on the estimated coordinates of the key point and the pixels in the target area comprises:

determining second direction vectors of the plurality of pixels in the target area pointing to the estimated coordinates of the key point respectively based on the estimated coordinates of the key point and coordinates of the plurality of pixels in the target area; determining inner products of the second direction vectors and the first direction vectors of the plurality of pixels in the target area;

determining a target quantity of pixels with the inner products greater than or equal to a predetermined threshold among the plurality of pixels in the target area; and determining the weights of the estimated coordinates of the key point based on the target quantity.

In a possible implementation, the determining the area in which the plurality of pixels of the image to be processed are located and the first direction vectors of the plurality of pixels pointing to the key point of the area comprises:

performing feature extraction processing on the image to be processed to obtain a first feature map with a preset resolution;

performing up-sampling processing on the first feature map to obtain a second feature map with the same resolution as the image to be processed; and

performing a first convolution processing on the second feature map to determine the area in which the plurality of pixels are located and the first direction vectors of the plurality of pixels pointing to the key point of the area.

In this way, after the second feature map with the same resolution as the image to be processed is obtained, convolution processing may be performed on the second feature map to reduce the processing amount and improve the processing efficiency.

In a possible implementation, the performing feature extraction processing on the image to be processed to obtain the first feature map with the preset resolution comprises:

performing a second convolution processing on the image to be processed to obtain a third feature map with a preset resolution; and

performing dilated convolution processing on the third feature map to obtain the first feature map.

In this way, the third feature map with the preset resolution may be obtained, with a less impact on processing accuracy. In addition, the receptive field is expanded through the dilated convolution processing, and any loss of processing accuracy may be avoided, thereby improving the processing accuracy of the feature extraction processing.

In a possible implementation, the area in which the plurality of pixels of the image to be processed are located and the first direction vectors of the plurality of pixels pointing to the key point of the area are determined via a neural network, and the neural network is trained by using a plurality of sample images with partition labels and key point labels.

According to another aspect of the present disclosure, a key point detection apparatus is provided, comprising:

a first determination module, configured to determine an area in which a plurality of pixels of an image to be processed are located and first direction vectors of the plurality of pixels pointing to a key point of the area, wherein the image to be processed comprises one or more areas; and

a second determination module, configured to determine the position of the key point in the area based on the area in which the pixels are located and the first direction vectors of the plurality of pixels in the area.

In a possible implementation, the second determination module is further configured to:

determine estimated coordinates of the key point in a target area and weights of the estimated coordinates of the key point based on the area in which the pixels are located and the first direction vectors, wherein the target area is any one of the one or more areas; and

perform weighted averaging on the estimated coordinates of the key point in the target area based on the weights of the estimated coordinates of the key point, to obtain the position of the key point in the target area.

In a possible implementation, the second determination module is further configured to: screen the plurality of pixels of the image to be processed based on the area in which the pixels are located, to determine a plurality of target pixels falling within the target area;

determine coordinates of the intersection of the first direction vectors of any two target pixels as estimated coordinates of the key point; and

determine the weights of the estimated coordinates of the key point based on the estimated coordinates of the key point and the pixels in the target area.

In a possible implementation, the second determination module is further configured to: determine second direction vectors of the plurality of pixels in the target area pointing to the estimated coordinates of the key point respectively based on the estimated coordinates of the key point and the coordinates of the plurality of pixels in the target area;

determine inner products of the second direction vectors and the first direction vectors of the plurality of pixels in the target area;

determine a target quantity of pixels with the inner products greater than or equal to a predetermined threshold among the plurality of pixels in the target area; and

determine the weights of the estimated coordinates of the key point based on the target quantity.

In a possible implementation, the first determination module is further configured to: perform feature extraction processing on the image to be processed to obtain the first feature map with the preset resolution;

perform up-sampling processing on the first feature map to obtain a second feature map with the same resolution as the image to be processed; and

perform a first convolution processing on the second feature map to determine the area in which the plurality of pixels are located and the first direction vectors pointing to the key point.

In a possible implementation, the first determination module is further configured to:

perform a second convolution processing on the image to be processed to obtain a third feature map with a preset resolution; and

performing dilated convolution processing on the third feature map to obtain the first feature map.

In a possible implementation, the first determination module is further configured to: determine, via a neural network, the area in which the plurality of pixels of the image to be processed are located and the first direction vectors of the plurality of pixels pointing to the key point of the area, the neural network is trained by using a plurality of sample images with partition labels and key point labels.

According to another aspect of the present disclosure, an electronic device is provided, comprising:

a processor; and

a memory for storing processor executable instructions;

wherein the processor is configured to execute the above key point detection method.

According to another aspect of the present disclosure, a computer-readable storage medium having computer program instructions stored thereon is provided, and the computer program instructions, when being executed by a processor, implement the above key point detection method.

According to the key point detection method in the embodiments of the present disclosure, a neural network may be used to obtain the area in which the plurality of pixels are located, and the estimated coordinates of the key point in the target area may be detected. The neural network expands the receptive field through a dilated convolution layer, and any loss of processing accuracy may be avoided, thereby improving the processing accuracy of the feature extraction operation. In addition, after the second feature map with the same resolution as the image to be processed is obtained, the second feature map may be subjected to convolution processing to reduce the processing amount and improve the processing efficiency. The estimated coordinates of the key point may be determined for each target area to reduce interferences between different areas, and the probability distribution of the position of the key point may be obtained by performing weighted averaging on the estimated coordinates of the key point to obtain the position of the key point, which improves the accuracy in determining the position of the key point. In addition, the situation where the target area is blocked or falls out of the image capturing range may be avoided, the robustness of key point detection is improved, and the accuracy of detection is increased. It should be understood that the above general description and the following detailed description are only exemplary and illustrative, rather than limiting the present disclosure.

Other features and aspects of the present disclosure will become apparent from the following detailed description of the exemplary embodiments with reference to the figures.

### BRIEF DESCRIPTION OF THE DRAWINGS

The figures herein are incorporated into the description and constitute a part thereof. These figures illustrate embodiments that conform to the present disclosure and are used together with the description to explain the technical solutions of the present disclosure.

FIG. 1 shows a flow diagram of a key point detection method according to an embodiment of the present disclosure;

FIG. 2 shows a flow diagram of the key point detection method according to the embodiment of the present disclosure;

FIG. 3 shows a schematic diagram of application of the key point detection method according to the embodiment of the present disclosure;

FIG. 4 shows a block diagram of a key point detection apparatus according to an embodiment of the present disclosure;

FIG. 5 shows a block diagram of an electronic device according to an embodiment of the present disclosure; and

FIG. 6 shows a block diagram of an electronic device according to an embodiment of the present disclosure.

### DETAILED DESCRIPTION OF THE EMBODIMENTS

Various exemplary embodiments, features, and aspects of the present disclosure will be described in details below with reference to the figures. Like reference numbers in the figures indicate elements with like or similar functions. Although various aspects of the embodiments are shown in the figures, the figures are not necessarily drawn to scale unless otherwise specifically noted.

The exclusive word “exemplary” here means “serving as an example, embodiment, or illustration”. Any embodiment described herein as “exemplary” is not necessarily construed as being superior to or better than other embodiments.

The term “and/or” herein is only an association relationship describing associated objects, which means that there may be three relationships. For example, A and/or B may refer to three situations: A alone exists; both A and B exist; and B alone exists. In addition, the term “at least one” herein means any one of, or any combination of at least two of, a plurality of objects, for example, including at least one of A, B, and C may mean including any one or more elements selected from the set formed by A, B and C.

In addition, in order to better illustrate the present disclosure, numerous specific details are given in the following specific embodiments. Those skilled in the art should understand that the present disclosure may also be implemented without some specific details. In some examples, methods, means, elements, and circuits well known to those skilled in the art are not described in details, so as to highlight the gist of the present disclosure.

FIG. 1 shows a flow diagram of a key point detection method according to an embodiment of the present disclosure. As shown in FIG. 1, the method includes the following steps.

In step S11, an area in which a plurality of pixels of an image to be processed are located and first direction vectors of the plurality of pixels pointing to a key point of the area are determined, wherein the image to be processed comprises one or more areas.

In step S12, the position of the key point in the area is determined based on the area in which the pixels are located and the first direction vectors of the plurality of pixels in the area.

According to the key point detection method in the embodiments of the present disclosure, the area in which the plurality of pixels are located and the first direction vectors of the plurality of pixels pointing to the key point of the area may be obtained, and the position of the key point in the area may be determined according to the first direction vectors. Thus, the situation where the target area is blocked or falls out of the image capturing range is avoided, the robustness of key point detection is improved, and the accuracy of detection is increased.

In a possible implementation, in step S11, a neural network may be used to obtain the area in which the plurality of pixels of the image to be processed are located and the first direction vectors pointing to the key point of the area. The neural network may be a convolution neural network, and the present disclosure does not limit the type of the neural network. In an example, an image to be processed including one or more target objects may be input to the neural network for processing, and parameters related to an area in which a plurality of pixels of the image to be processed are located, as well as first direction vectors of the plurality of pixels pointing to the key point of the area in which the plurality of pixels are located, may be obtained. Alternatively, other methods may be used to obtain the area in which the plurality of pixels of the image to be processed are located, for example, at least one area in the image to be processed may be distinguished by means such as semantic segmentation. The present disclosure does not limit the means for obtaining the area in which the plurality of pixels of the image to be processed are located.

In an example, if there are two target objects A and B in an image to be processed, then the image to be processed may be divided into three areas, namely, area A in which the target object A is located, area B in which the target object B is located, and background area C. Any parameter of the area may be used to indicate the area in which a pixel is located. For example, if a pixel with coordinates (10, 20) is in the area A, the pixel may be expressed as (10, 20, A), and if a pixel with coordinates (50, 80) is in the background area, the pixel may be expressed as (50, 80, C).

In another example, the area in which a pixel is located may also be expressed by a probability that the pixel is in a certain area. For example, if the probability of a certain pixel falling into the area A is 60%, the probability of falling into the area B is 10%, the probability of falling into the area D is 15%, and the probability of falling into the background area is 15%, it may be determined that the pixel falls into the area A. Alternatively, a numerical interval is used to indicate the area in which a pixel is located. For example, the neural network may output a parameter x that represents the area in which a certain pixel is located. If 0≤x<25, the pixel falls into the area A. If 25≤x<50, the pixel falls into the area B. If 50≤x<75, the pixel falls into the area D. And if 75≤x≤100, the pixel falls into the background area. The present disclosure does not limit the parameter representing the area in which a pixel is located. In an example, a plurality of area may also be a plurality of areas of one target object. For example, the target object is a human face, the area A is a forehead area, and the area B is a cheek area . . . . The present disclosure does not limit the areas.

In an example, the neural network may also obtain a direction vector pointing from a pixel to a key point in an area in which the pixel is located. For example, the direction vector may be a unit vector, and the unit vector may be determined according to the following formula (1):

$${v}_{k} ( p ) = \frac{{x}_{k} - p}{{‖ {x}_{k} - p ‖}_{2}} \qquad ( 1 )$$

wherein, vₖ(p) is the first direction vector, p is any pixel in the k-th (k is a positive integer) area, xₖ is the key point of the k-th area in which p is located, ∥xₖ−p∥₂ is the modulus of the vector xₖ−p, that is, the first direction vector vₖ(p) is a unit vector.

In an example, the area in which the pixel is located and the first direction vector may be expressed together with the coordinates of the pixel, for example, (10, 20, A, 0.707, 0.707), wherein (10, 20) is the coordinates of the pixel, A indicates that the area in which the pixel is located is the area A, and (0.707, 0.707) is the first direction vector of the pixel pointing to the key point of the area A.

In a possible implementation, the step S11 includes: performing feature extraction processing on the image to be processed to obtain a first feature map with a preset resolution; performing up-sampling processing on the first feature map to obtain a second feature map with the same resolution as the image to be processed; and

performing a first convolution processing on the second feature map to determine the area in which the plurality of pixels are located and the first direction vectors of the plurality of pixels pointing to the key point of the area.

In a possible implementation, a neural network may be used to determine the area in which the plurality of pixels of the image to be processed are located and the first direction vectors of the plurality of pixels pointing to the key point of the area. The neural network includes at least a down-sampling sub-network, an up-sampling sub-network, and a feature determination sub-network.

In a possible implementation, performing feature extraction processing on the image to be processed to obtain a first feature map with a preset resolution includes: performing a second convolution processing on the image to be processed to obtain a third feature map with a preset resolution; and performing dilated convolution processing on the third feature map to obtain the first feature map.

In a possible implementation, the down-sampling sub-network may be used to perform down-sampling processing on the image to be processed. The down-sampling sub-network may include a second convolution layer and a dilated convolution layer, wherein the second convolution layer of the down-sampling sub-network may perform second convolution processing on the image to be processed. The second convolution layer may also include a pooling layer, which may perform pooling and other processing on the image to be processed. After processing by the second convolution layer, a third feature map with a preset resolution may be obtained. In an example, the third feature map is a feature map with a preset resolution. For example, the resolution of the image to be processed is H×W (H and W are positive integers), and the preset resolution is H/8×W/8. The present disclosure does not limit the preset resolution. In a possible implementation, after the third feature map with the preset resolution is obtained, in order to prevent the processing accuracy from further degrading, down-sampling processing such as pooling may not be performed, and the dilated convolution layer is used instead for feature extraction processing. The third feature map with the preset resolution may be input into the dilated convolution layer for dilated convolution processing, so as to obtain the first feature map. The dilated convolution layer may expand the receptive field of the third feature map without further reducing the resolution, thereby improving the processing accuracy.

In an example, the image to be processed may also be subjected to down-sampling by means of interval sampling or the like, to obtain the first feature map with the preset resolution. The present disclosure does not limit the means for obtaining the first feature map with the preset resolution.

In this way, the third feature map with the preset resolution may be obtained, with a less impact on processing accuracy. In addition, the receptive field is expanded through the dilated convolution processing without any loss of processing accuracy, thereby improving the processing accuracy of the feature extraction processing.

In a possible implementation, the first feature map may be subjected to up-sampling processing through the up-sampling sub-network, that is, the first feature map may be input into the up-sampling sub-network for up-sampling processing, to obtain the second feature map with the same resolution as the image to be processed (for example, the resolution of the second feature map is H×W). In an example, the up-sampling sub-network may include a deconvolution layer, and the first feature map may be subjected to up-sampling through deconvolution processing. In an example, the first feature map may also be subjected to up-sampling through processing such as interpolation. The present disclosure does not limit the means for up-sampling processing.

In a possible implementation, the second feature map may be subjected to the first convolution processing through the feature determination sub-network. In an example, the feature determination sub-network includes a first convolution layer through which the first convolution processing may be performed on the second feature map, and the area in which the plurality of pixels are located and the first direction vectors of the plurality of pixels pointing to the key point of the area may be determined.

In a possible implementation, the resolution of the second feature map is the same as the resolution of the image to be processed, and full connection processing may not be performed. That is, the feature determination sub-network may not include a full connection layer. The feature determination sub-network may include a first convolution layer with one or more 1×1 convolution kernels. Through the first convolution layer, the second feature map may be subjected to the first convolution processing to obtain the area in which the plurality of pixels of the second feature map are located and the first direction vectors pointing to the key point. Since the second feature map has the same resolution as the image to be processed, the area in which the plurality of the pixels of the second feature map are located and the first direction vectors of the plurality of pixels pointing to key point of the area may be determined as the area in which the plurality of pixels of the image to be processed are located and the first direction vectors of the plurality of pixels pointing to the key point of the area. For example, a pixel with the coordinates (10, 20) in the second feature map may be processed by the feature determination sub-network to obtain an output of (10, 20, A, 0.707, 0.707), which means that the area in which the pixel with the coordinates (10, 20) is located is area A, and the first direction vector of the pixel pointing to the key point of the area A is (0.707, 0.707). The output may be used to represent the area in which the pixel with the coordinates (10, 20) of the image to be processed is located and the first direction vector of the pixel pointing to the key point of the area in which the pixel is located, that is, the area in which the pixel with the coordinates (10, 20) in the image to be processed is located is the area A, and the first direction vector of the pixel pointing to the key point of the area A is (0.707, 0.707).

In this way, after the second feature map with the same resolution as the image to be processed is obtained, convolution processing may be performed on the second feature map to reduce the processing amount and improve the processing efficiency.

In a possible implementation, the step S12 may determine the positions of key points in a plurality of areas based on the area in which the pixels are located and the first direction vectors of the plurality of pixels in the plurality of areas, that is, coordinates of the key points in the plurality of areas. The step S12 may include: determining estimated coordinates of the key point in a target area and weights of the estimated coordinates of the key point based on the area in which the pixels are located and the first direction vectors, wherein the target area is any one of the one or more areas; and

performing weighted averaging on the estimated coordinates of the key point in the target area based on the weights of the estimated coordinates of the key point, to obtain the position of the key point in the target area.

In an example, the position of the key point may also be determined based on the pointing direction of the first direction vector. The present disclosure does not limit the means for determining the position of the key point.

In a possible implementation, the determining the estimated coordinates of the key point in the target area and the weights of the estimated coordinates of the key point based on the area in which the pixels are located and the first direction vectors may include: screening the plurality of pixels of the image to be processed based on the area in which the pixels are located, to determine a plurality of target pixels falling into the target area; determining coordinates of the intersection of the first direction vectors of any two target pixel points as estimated coordinates of the key point, wherein the estimated coordinates of the key point is one of the estimated coordinates of the key point; and determining the weights of the estimated coordinates of the key point based on the estimated coordinates of the key point and the pixels in the target area.

In a possible implementation, all pixels in the target area may be screened out as the target pixels. For example, all pixels in the target area may be screened out through the output by the neural network for the area in which the plurality of pixels are located. In an example, the target area is the area A. From all the pixels of the image to be processed, all pixels for which the output of the neural network is the area A may be screened out. The area composed of these pixels is the area A. The present disclosure has no limitation to the target area.

In a possible implementation, in the target area (for example, the area A), any two target pixels may be selected, both of which have the first direction vectors. The first direction vectors of the two target pixels both point to the key point of the target area. The intersection of the two first direction vectors may be determined. This intersection is the estimated position of the key point, i.e. the estimated coordinates of the key point. In an example, the first direction vector of each target pixel may subject to errors. Therefore, the estimated coordinates of the key point are not unique, that is, the estimated coordinates of the key point determined by the intersection of the first direction vectors of two target pixels may be different from the estimated coordinates of the key point determined by the intersection of the first direction vectors of another two target pixels. The intersections of the first direction vectors of any two target pixels may be obtained in this way multiple times, to obtain the estimate coordinates of the key point.

In a possible implementation, the weights of the estimated coordinates of the key point may be determined. The determining the weights of the estimated coordinates of the key point based on the estimated coordinates of the key point and the pixels in the target area includes: determining second direction vectors of the plurality of pixels in the target area pointing to the estimated coordinates of the key point respectively based on the estimated coordinates of the key point and coordinates of the plurality of pixels in the target area; determining inner products of the second direction vectors and the first direction vectors of the plurality of pixels in the target area; determining a target quantity of pixels with the inner products greater than or equal to a predetermined threshold among the plurality of pixels in the target area; and determining the weights of the estimated coordinates of the key point based on the target quantity.

In a possible implementation, the weights of the estimated coordinates of the key point may be determined for one estimated coordinate of the key point. Second direction vectors of the plurality of pixels in the area in which the estimated coordinates of the key point are located pointing to the estimated coordinates of the key point may be obtained. The second direction vector may be a unit vector. The weights of the estimated coordinates of the key point may be determined by using the second direction vectors of the plurality of target pixels in the target area pointing to the estimated coordinates of the key point and the first direction vectors of the plurality of target pixels pointing to the key point in the target area.

In a possible implementation, the weights of the estimated coordinates of the key point may be determined based on the second direction vectors and the first direction vectors of the plurality of pixels in the target area. The inner products of the second direction vectors and the first direction vectors of the plurality of pixels in the target area may be determined. The inner products corresponding to the plurality of pixels may be compared with a predetermined threshold, and a target quantity of the pixels with the inner products greater than the predetermined threshold may be determined. For example, if a pixel has an inner product greater than the predetermined threshold, then it is marked as 1, otherwise it is marked as 0. After all the pixels in the target area are marked, the labels of all the pixels are added together and thus the target quantity may be determined.

In a possible implementation, the weights of the estimated coordinates of the key point may be determined by the target quantity. In an example, the weights of the estimated coordinates of the key point may be determined according to the following formula (2):

$${w}_{k , i} = {\sum }_{{p}^{′} ∈ O} 𝕀 ( \frac{{( {h}_{k , i} - {p}^{′} )}^{T}}{{‖ {h}_{k , i} - {p}^{′} ‖}_{2}} {v}_{k} ( {p}^{′} ) \geq θ ) \qquad ( 2 )$$

wherein w_{k,i} is the weight of the i-th estimated coordinates of the key point (for example, this key point) in the k-th area (for example, area A), O is all the pixels in the area, p′ is any pixel in the area, h_{k,i} is the i-th estimated coordinates of the key point in the area,

$$\frac{{( {h}_{k , i} - {p}^{′} )}^{T}}{{‖ {h}_{k , i} - {p}^{′} ‖}_{2}}$$

is the second direction vector of p′ pointing to h_{k,i}, vₖ(p′) is the first direction vector of p′, and θ is the predetermined threshold. In the example, the value of θ may be 0.99. The present disclosure does not limit the predetermined threshold. II is an activation function, which means that if the inner product of

$$\frac{{( {h}_{k , i} - {p}^{′} )}^{T}}{{‖ {h}_{k , i} - {p}^{′} ‖}_{2}}$$

and vₖ(p′) is greater than or equal to the predetermined threshold θ, the value of II is 1 (that is, marked as 1), otherwise, the value of II is 0 (that is, marked as 0). The formula (2) may represent the result obtained by adding the values of the activation functions (i.e., markers) of all the pixels in the target area, i.e. the weight of the estimated coordinates h_{k,i} of the key point. The present disclosure does not limit the value of the activation function when the inner product is greater than or equal to the predetermined threshold.

In a possible implementation, the above processing for determining the estimated coordinates of the key point and the weights of the estimated coordinates of the key point may be performed iteratively, and the plurality of estimated coordinates of the key point in the target area and the weights of the estimated coordinates of the key point may be obtained.

In a possible implementation, weighted averaging may be performed on the estimated coordinates of the key point in the target area based on the weights of the estimated coordinates of the key point, to obtain the position of the key point in the target area. In an example, the position of the key point in the target area may be determined according to the following formula (3):

$${μ}_{k} = \frac{{\sum }_{i = 1}^{N} {w}_{k , i} {h}_{k , i}}{{\sum }_{i = 1}^{N} {w}_{k , i}} \qquad ( 3 )$$

wherein, μₖ is the coordinates obtained after weighted averaging is performed on N (N is a positive integer) estimated coordinates of the key point in the k-th area (for example, area A), i.e. the position coordinates of the key point in the k-th area.

In a possible implementation, a maximum likelihood estimation method may also be used to determine a covariance matrix corresponding to the key point, i.e. the matrix obtained by performing weighted averaging on the covariance matrix between the estimated coordinates of the key point and the position coordinates of the key point in the target area. In an example, the following formula (4) may be used to represent the covariance matrix Σₖ corresponding to the key point:

$${\sum }_{k} = \frac{{\sum }_{i = 1}^{N} {w}_{k . i} ( {h}_{k . i} - {μ}_{k} ) {( {h}_{k , i} - {μ}_{k} )}^{T}}{{\sum }_{i = 1}^{N} {w}_{k , i}} \qquad ( 4 )$$

In a possible implementation, the position coordinates of the key point and the covariance matrix corresponding to the key point may be used to represent the probability distribution of the possible position of the key point in the target area. In a possible implementation, the above processing for obtaining the position of the key point of the target area may be iteratively performed to obtain the positions of the key points in a plurality of areas of the image to be processed.

In this way, the estimated coordinates of the key point in the target area may be detected, and the estimated coordinates of the key point may be determined for each target area, which reduces interferences between different areas and improves the accuracy of key point detection. Furthermore, the estimated coordinates of the key point may be determined by the second direction vectors. The weights of the estimated coordinates of the key point may be determined by the inner products of the first direction vectors and the second direction vectors. The probability distribution of the position of the key point may be obtained by performing weighted averaging on the estimated coordinates of the key point to obtain the position of the key point, which improves the accuracy in determining the position of the key point.

In a possible implementation, a neural network may be trained before it is used to obtain the area in which the plurality of pixels are located and the first direction vectors pointing to the key point.

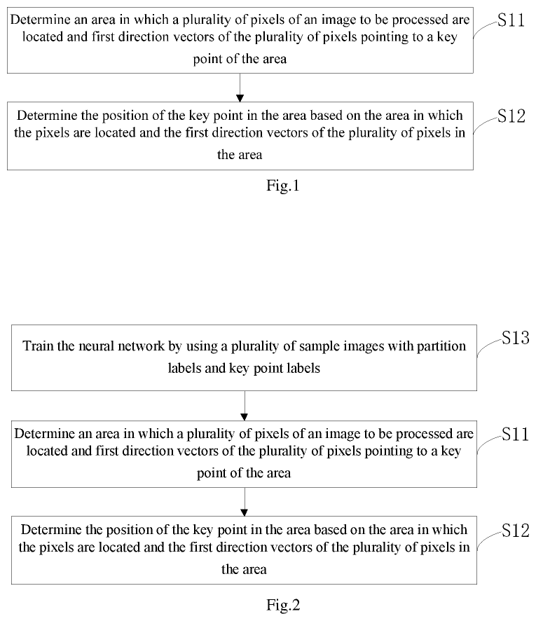

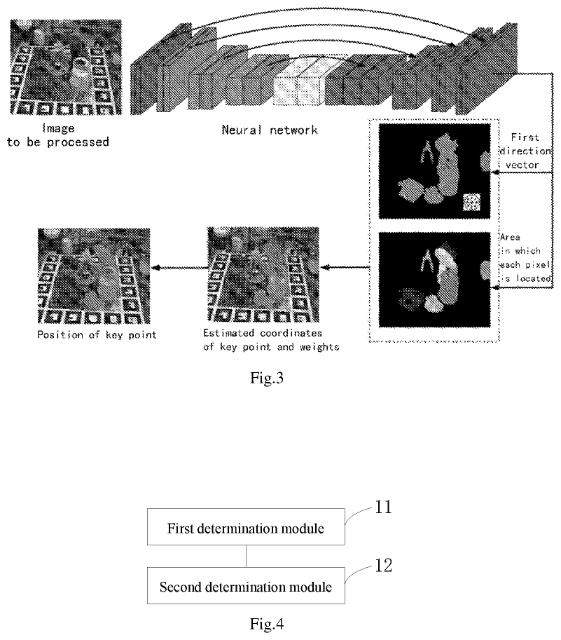

FIG. 2 shows a flow diagram of the key point detection method according to the embodiment of the present disclosure. As shown in FIG. 2, the method further includes the following steps.

In step S13, the neural network is trained through a plurality of sample images with partition labels and key point labels.

Wherein, it is not necessary to perform step 13 every time steps 11 and 12 are performed. Once training for the neural network is completed, the neural network may be used to determine the first sample direction vectors and the partition result. In other words, once training for the neural network is completed, the neural network may be used to implement the functions of step 11 and step 12 multiple times.

In a possible implementation, any sample image may be input to the neural network for processing, and the first sample direction vectors of the plurality of pixels of the sample image and the partition result of the area in which the plurality of pixels are located may be obtained. The first sample direction vectors and the partition result are an output from the neural network, and there may be errors.

In a possible implementation, the first direction vectors of the key points in a plurality of areas may be determined based on the key point labels. For example, if the coordinates of a key point labeled in a certain area are (10, 10), then the first direction vector of the pixel with the coordinates (5, 5) pointing to the key point is (0.707, 0.707). In a possible implementation, the network loss of the neural network may be determined based on the difference between the first direction vector and the first sample direction vector as well as the difference between the partition result and the partition labels. In an example, the cross entropy loss function of the plurality of pixels may be determined based on the difference between the first direction vector and the first sample direction vector as well as the difference between the partition result and the partition labels, and regularization processing is performed on the cross entropy loss function to prevent overfitting during training. The cross-entropy loss function after the regularization processing may be determined as the network loss of the neural network.

In a possible implementation, the network parameters of the neural network may be adjusted according to the network loss. In an example, the network parameters may be adjusted in the direction of minimizing the network loss. For example, the network loss may be propagated back using gradient descent, in order to adjust the network parameters of the neural network. In addition, when the neural network meets a training condition, the trained neural network is obtained. The training condition may be the number of times of adjustments, and the network parameters of the neural network may be adjusted by a predetermined number of times. In another example, the training condition may be the size or convergence and divergence of the network loss. When the network loss decreases to a certain degree or converges within a certain threshold, the adjustment may be stopped to obtain the trained neural network, and the trained neural network may be used in the processing for obtaining the area in which the plurality of pixels of the image to be processed are located and the first direction vectors pointing to the key point.

According to the key point detection method in the embodiments of the present disclosure, the neural network may be used to obtain the area in which the plurality of pixels are located, and the estimated coordinates of the key point in the target area may be detected. The neural network expands the receptive field through a dilated convolution layer without any loss of processing accuracy, thereby improving the processing accuracy of the feature extraction operation. In addition, after the second feature map with the same resolution as the image to be processed is obtained, the second feature map may be subjected to convolution processing to reduce the processing amount and improve the processing efficiency. The estimated coordinates of the key point may be determined for each target area to reduce interferences between different areas, and the probability distribution of the position of the key point may be obtained by performing weighted averaging on the estimated coordinates of the key point to obtain the position of the key point, which improves the accuracy in determining the position of the key point. Thus, the situation where the target area is blocked or falls out of the image capturing range is avoided, the robustness of key point detection is improved, and the accuracy of detection is increased.

FIG. 3 shows a schematic diagram of application of the key point detection method according to the embodiment of the present disclosure. As shown in FIG. 3, the image to be processed may be input into a pre-trained neural network for processing, and the area in which the plurality of pixels of the image to be processed are located and the first direction vectors pointing to the key point may be obtained. In an example, feature extraction processing may be performed on the image to be processed through the down-sampling sub-network of the neural network, that is, the second convolution processing is performed through the second convolution layer of the down-sampling sub-network, and the dilated convolution processing is performed through the dilated convolution layer, so as to obtain a first feature map with a preset resolution. Up-sampling processing is performed on the first feature map to obtain a second feature map with the same resolution as the image to be processed. The second feature map may be input to the first convolution layer (with one or more 1×1 convolution kernels) of the feature determination sub-network to perform the first convolution processing, so as to obtain the area in which the plurality of pixels are located and the first direction vectors pointing to the key point.

In a possible implementation, among the plurality of pixels in the target area, the intersection of the first direction vectors of any two pixels may be determined as estimated coordinates of the key point. The estimated coordinates of the key point in the target area may be determined in this way.

In a possible implementation, the weights of the estimated coordinates of the key point may be determined. In an example, the second direction vectors of the plurality of pixels in the target area pointing to the estimated coordinates of a certain key point may be determined. The inner products of the second direction vectors and the first direction vectors of the plurality of pixels are determined. Also, the weights of the estimated coordinates of the key point may be determined using an activation function according to formula (2). That is, when the inner product is greater than or equal to a predetermined threshold, the value of the activation function is 1, otherwise it is 0.

Furthermore, the values of the activation functions of the plurality of pixels in the target area may be added together, to obtain the weights of the estimated coordinates of the key point. The weights of the estimated coordinates of the key point in the target area may be determined in this way.

In a possible implementation, weighted averaging may be performed on the estimated coordinates of the key point in the target area to obtain the position coordinates of the key point in the target area, and the position coordinates of the key point in each area may be determined in this way.

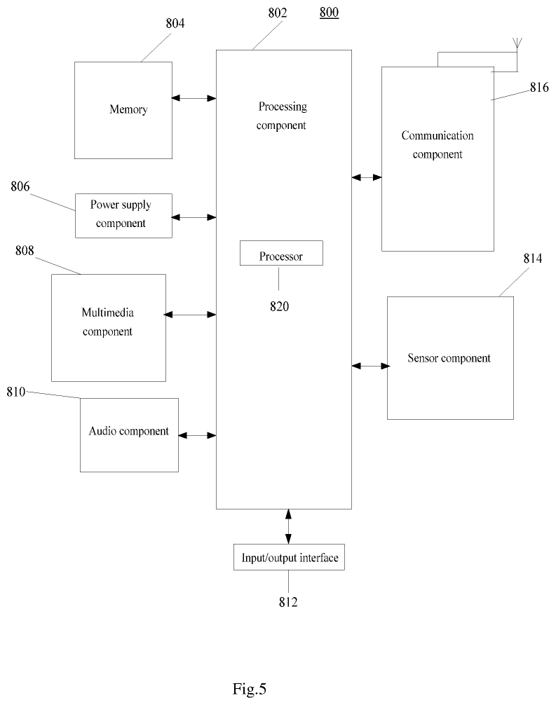

FIG. 4 shows a block diagram of a key point detection apparatus according to an embodiment of the present disclosure. As shown in FIG. 4, the apparatus includes: a first determination module 11 for determining an area in which a plurality of pixels of an image to be processed are located and first direction vectors of the plurality of pixels pointing to a key point of the area, wherein the image to be processed comprises one or more areas;

a second determination module 12 for determining the position of the key point in the area based on the area in which the pixels are located and the first direction vectors of the plurality of pixels in the area.

In a possible implementation, the second determination module is further configured to: determine estimated coordinates of the key point in a target area and weights of the estimated coordinates of the key point based on the area in which the pixels are located and the first direction vectors, wherein the target area is any one of the one or more areas; and

perform weighted averaging on the estimated coordinates of the key point in the target area based on the weights of the estimated coordinates of the key point, to obtain the position of the key point in the target area.

In a possible implementation, the second determination module is further configured to: screen the plurality of pixels of the image to be processed based on the area in which the pixels are located, to determine a plurality of target pixels falling within the target area;

determine coordinates of the intersection of the first direction vectors of any two target pixels as estimated coordinates of the key point; and

determine the weights of the estimated coordinates of the key point based on the estimated coordinates of the key point and the pixels in the target area.

In a possible implementation, the second determination module is further configured to: determine second direction vectors of the plurality of pixels in the target area pointing to the estimated coordinates of the key point respectively based on the estimated coordinates of the key point and coordinates of the plurality of pixels in the target area; determine inner products of the second direction vectors and the first direction vectors of the plurality of pixels in the target area;

determine a target quantity of pixels with the inner products greater than or equal to a predetermined threshold among the plurality of pixels in the target area; and

determine the weights of the estimated coordinates of the key point based on the target quantity.

In a possible implementation, the first determination module is further configured to:

perform feature extraction processing on the image to be processed to obtain a first feature map with a preset resolution;

perform up-sampling processing on the first feature map to obtain a second feature map with the same resolution as the image to be processed; and

perform a first convolution processing on the second feature map to determine the area in which the plurality of pixels are located and the first direction vectors pointing to the key point.

In a possible implementation, the first determination module is further configured to:

perform a second convolution processing on the image to be processed to obtain a third feature map with a preset resolution; and

perform dilated convolution processing on the third feature map to obtain the first feature map.

In a possible implementation, the first determination module is further configured to: determine, via a neural network, the area in which the plurality of pixels of the image to be processed are located and the first direction vectors of the plurality of pixels pointing to the key point of the area, where the neural network is trained by using a plurality of sample images with partition labels and key point labels.

It may be understood that the various method embodiments mentioned above in the present disclosure may be combined with each other to form combined embodiments without violating principles and logic. Due to space limitations, these embodiments will not be described in the present disclosure.

In addition, the present disclosure also provides a key point detection apparatus, an electronic device, a computer readable storage medium and a program, all of which may be used to implement any key point detection method provided in the present disclosure. For the corresponding technical solutions and descriptions, reference is made to the corresponding statements in the method section, and no description will be given here.

Those skilled in the art may understand that in the above methods in the detailed description, the order in which the steps are written does not imply a strict execution order so that there is no limitation to the implementation process. The specific execution order of the steps should be based on their functions and possible inner logic.

In some embodiments, the functions of, or the modules contained in, the apparatus provided in the embodiments of the present disclosure may be used to execute the methods described in the above method embodiments. For specific implementation, reference is made to the description in the above method embodiments. It will not be described here for simplicity.

The embodiments of the present disclosure also provides a computer-readable storage medium having computer program instructions stored thereon, and the computer program instructions, when being executed by a processor, implement the above method. The computer-readable storage medium may be a non-volatile computer-readable storage medium.

The embodiments of the present disclosure also provide a computer program product comprising computer-readable codes. When the computer-readable codes run on a device, a processor in the device executes instructions to implement the image search method as provided in any of the above embodiments.

The embodiments of the present disclosure also provide another computer program product for storing computer-readable instructions, which, when executed, cause a computer to perform the operations of the image search method provided in any of the foregoing embodiments.

The computer program product may be specifically implemented in hardware, software or a combination thereof. In an optional embodiment, the computer program product is embodied as a computer storage medium. And in another optional embodiment, the computer program product is embodied as a software product, such as software development kit (SDK), etc.

The embodiments of the present disclosure also provide an electronic device, including: a processor; and a memory for storing processor-executable instructions; wherein the processor is configured to execute the above method.

The electronic device may be provided as a terminal, a server or other form of device.

FIG. 5 is a block diagram showing an electronic device 800 according to an exemplary embodiment. For example, the electronic device 800 may be a mobile phone, a computer, a digital broadcasting terminal, a messaging device, a game console, a tablet device, a medical device, a fitness device, a personal digital assistant, and other such terminals.

As shown in FIG. 5, the electronic device 800 may include one or more of the following components: a processing component 802, a memory 804, a power supply component 806, a multimedia component 808, an audio component 810, an input/output (I/O) interface 812, a sensor component 814, and a communication component 816.

The processing component 802 generally controls the overall operations of the electronic device 800, such as operations associated with display, telephone calls, data communication, camera operations, and recording operations. The processing component 802 may include one or more processors 820 to execute instructions, for purposes of completing all or some of the steps of the foregoing method. In addition, the processing component 802 may include one or more modules to facilitate interactions between the processing component 802 and other components. For example, the processing component 802 may include a multimedia module to facilitate the interaction between the multimedia component 808 and the processing component 802.

The memory 804 is configured to store various types of data to support operations in the electronic device 800. Examples of the data include instructions for any application or method operating on the electronic device 800, contact data, phone book data, messages, pictures, videos, etc. The memory 804 may be implemented by any type of volatile or non-volatile storage device or their combinations, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk or optical disk.

The power supply component 806 supply power for the various components of the electronic device 800. The power supply component 806 may include a power management system, one or more power supplies, and other components associated with generation, management, and distribution of the power for the electronic device 800.

The multimedia component 808 includes a screen that provides an output interface between the electronic device 800 and a user. In some embodiments, the screen may include a liquid crystal display (LCD) and a touch panel (TP). If the screen includes the touch panel, the screen may be implemented as a touch screen to receive an input signal from the user. The touch panel includes one or more touch sensors to sense touch, sliding, and gestures on the touch panel. The touch sensor may not only sense the boundary of a touch or sliding action, but also detect the duration and pressure related to the touch or sliding operation. In some embodiments, the multimedia component 808 includes a front camera and/or a rear camera. When the electronic device 800 is in an operation mode such as a capturing mode or a video mode, the front camera and/or the rear camera may receive external multimedia data. Each front camera and rear camera may be a fixed optical lens system or have focal length and optical zooming capabilities.

The audio component 810 is configured to output and/or input audio signals. For example, the audio component 810 includes a microphone (MIC). When the electronic device 800 is in an operation mode such as a call mode, a recording mode, and a voice recognition mode, the microphone is configured to receive external audio signals. The received audio signals may be further stored in the memory 804 or transmitted via the communication component 816. In some embodiments, the audio component 810 further includes a speaker for outputting audio signals.

The I/O interface 812 provides an interface between the processing component 802 and a peripheral interface module. The above peripheral interface module may be a keyboard, a click wheel, a button, etc. These buttons may include but are not limited to: home button, volume button, start button, and lock button.

The sensor component 814 includes one or more sensors for providing the electronic device 800 with state evaluation in various aspects. For example, the sensor component 814 may detect the on/off state of the electronic device 800 and the relative positioning of the components. For example, the component is a display and a keypad of the electronic device 800. The sensor component 814 may also detect a change in the position of the electronic device 800 or of one component of the electronic device 800, the presence or absence of contact between the user and the electronic device 800, the orientation or acceleration/deceleration of the electronic device 800, and a change in the temperature of the electronic device 800. The sensor component 814 may include a proximity sensor configured to detect the presence of nearby objects when there is no physical contact. The sensor component 814 may also include a light sensor, such as a CMOS or CCD image sensor, for use in imaging applications. In some embodiments, the sensor component 814 may also include an acceleration sensor, a gyroscope sensor, a magnetic sensor, a pressure sensor or a temperature sensor.

The communication component 816 is configured to facilitate wired or wireless communications between the electronic device 800 and other devices. The electronic device 800 may access a wireless network based on a communication standard, such as WiFi, 2G or 3G, or combinations thereof. In an exemplary embodiment, the communication component 816 receives a broadcast signal or broadcast-related information from an external broadcast management system via a broadcast channel. In an exemplary embodiment, the communication component 816 further includes a near-field communication (NFC) module to facilitate short-range communication. For example, the NFC module may be implemented based on radio frequency identification (RFID) technology, infrared data association (IrDA) technology, ultra-wideband (UWB) technology, Bluetooth (BT) technology and other technologies.

In an exemplary embodiment, the electronic device 800 may be implemented by one or more application specific integrated circuits (ASIC), digital signal processors (DSP), digital signal processing devices (DSPD), programmable logic devices (PLD), field programmable gate array (FPGA), controllers, microcontrollers, microprocessors, or other electronic components, to implement the above method.

In an exemplary embodiment, also provided is a non-volatile computer-readable storage medium, such as the memory 804 including computer program instructions, and the computer program instructions above may be executed by the processor 820 of the electronic device 800 to complete the above method.

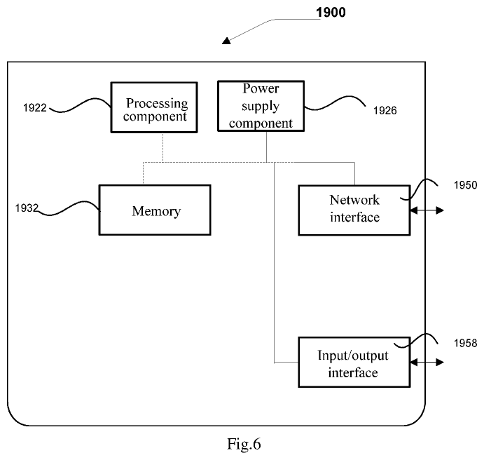

FIG. 6 is a block diagram of an electronic device 1900 shown according to an exemplary embodiment. For example, the electronic device 1900 may be provided as a server. With reference to FIG. 6, the electronic device 1900 includes a processing component 1922, which further includes: one or more processors; and a memory resource represented by a memory 1932, for storing instructions executable by the processing component 1922, such as application. The application stored in the memory 1932 may include one or more modules each corresponding to a set of instructions. In addition, the processing component 1922 is configured to execute instructions to perform the above-described method.

The electronic device 1900 may also include a power supply component 1926 configured to perform power management of the electronic device 1900, a wired or wireless network interface 1950 configured to connect the electronic device 1900 to a network, and an input/output (I/O) interface 1958. The electronic device 1900 may operate based on an operating system stored in the memory 1932, such as Windows Server™, Mac OS X™, Unix™, Linux™, FreeBSD™ or the like.

In an exemplary embodiment, also provided is a non-volatile computer-readable storage medium, such as the memory 1932 including computer program instructions, and the computer program instructions above may be executed by the processing component 1922 of the electronic device 1900 to complete the above method.

The present disclosure may be a system, a method, and/or a computer program product. The computer program product may include a computer-readable storage medium loaded thereon with computer-readable program instructions for enabling a processor to implement the various aspects of the present disclosure.

The computer-readable storage medium may be a tangible device that may keep and store instructions used by an instruction execution device. The computer-readable storage medium may be, for example, but not limited to, an electrical storage device, a magnetic storage device, an optical storage device, an electromagnetic storage device, a semiconductor storage device, or any suitable combination thereof. More specific examples of the computer-readable storage medium (a non-exhaustive list) include: portable computer disk, hard disk, random access memory (RAM), read-only memory (ROM), erasable programmable read-only memory (EPROM or flash memory), static random access memory (SRAM), portable compact disk read-only memory (CD-ROM), digital versatile disk (DVD), memory stick, floppy disk, mechanical encoding device, such as a puncher card with instructions stored thereon or the protruding structure in the groove, and any suitable combination of the above. The computer-readable storage medium used here is not interpreted as a transient signal itself, such as radio waves or other freely propagating electromagnetic waves, electromagnetic waves propagating through waveguides or other transmission media (for example, light pulses through fiber optic cables), or electrical signals transmitted through wires.

The computer-readable program instructions described herein may be downloaded from a computer-readable storage medium to various computing/processing devices, or downloaded to an external computer or an external storage device via a network, such as Internet, local area network, wide area network, and/or wireless network. The network may include copper transmission cables, optical fiber transmission, wireless transmission, router, firewall, switch, gateway computer, and/or edge server. The network adapter card or network interface in each computing/processing device receives computer-readable program instructions from a network, and forwards the computer-readable program instructions for storage in the computer-readable storage medium in each computing/processing device.

The computer program instructions used to perform the operations of the present disclosure may be assembly instructions, instruction set architecture (ISA) instructions, machine instructions, machine-related instructions, microcodes, firmware instructions, state setting data, or source codes or object codes written in one of or any combination of a plurality of programming languages. The programming language includes an object-oriented programming language such as Smalltalk, C++, etc., and a conventional procedural programming language such as “C” language or similar programming languages. The computer readable program instructions may be executed entirely on the user's computer, partly on the user's computer, as a stand-alone software package, partly on the user's computer and partly on a remote computer, or entirely on the remote computer or server. In the latter scenario, the remote computer may be connected to the user's computer through a local area network (LAN) or a wide area network (WAN), or the connection may be made to an external computer (for example, through the Internet using an Internet Service Provider). In some embodiments, an electronic circuit, such as a programmable logic circuit, a field programmable gate array (FPGA), or a programmable logic array (PLA), may be customized by using the status information of the computer-readable program instructions. The electronic circuit may execute the computer-readable program instructions to implement various aspects of the present disclosure.

Various aspects of the present disclosure are described herein with reference to flowchart illustrations and/or block diagrams of methods, apparatuses (systems) and computer program products according to the embodiments of the present disclosure. It will be understood that each block of the flowchart illustrations and/or block diagrams, and combinations of blocks in the flowchart illustrations and/or block diagrams, can be implemented by computer program instructions.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium. These instructions make computers, programmable data processing apparatuses, and/or other devices work in a specific manner, so that the computer-readable medium storing the instructions includes an article including instructions for implementing various aspects of the functions/actions specified in one or more blocks in the flowchart and/or block diagram.

The computer program instructions may also be loaded onto a computer, other programmable data processing apparatuses or other devices to cause a series of operational steps to be performed on the computer or other programmable data processing apparatuses to produce a computer implemented process such that the instructions which execute on the computer, other programmable data processing apparatuses or other devices implement the functions/acts specified in the flowchart and/or block diagram block or blocks.

The flowcharts and block diagrams in the figures show the possible implementation architectures, functions, and operations of the system, method, and computer program product according to various embodiments of the present disclosure. In this regard, each block in the flowchart or block diagram may represent a module, a program segment, or a part of an instruction, and the module, the program segment, or the part of the instruction contains one or more executable instructions for implementing the specified logical functions. In some alternative implementations, the functions marked in the blocks may also occur in a different order from the order marked in the figures. For example, two consecutive blocks may actually be executed substantially in parallel, or they may sometimes be executed in the reverse order, depending on the functions involved. It should also be noted that each block in the block diagram and/or flowchart, and the combination of blocks in the block diagram and/or flowchart, may be implemented by a dedicated hardware-based system that performs the specified functions or actions, or it may be implemented by a combination of dedicated hardware and computer instructions.

The various embodiments of the present disclosure have been described above. The above description is exemplary, not exhaustive, and is not limited to the disclosed embodiments. Without departing from the scope and spirit of the described embodiments, many modifications and changes are apparent to those of ordinary skill in the art. The selection of terms used herein is intended to best explain the principles of the embodiments, practical applications, or technical improvements of the technologies in the market, or to enable other ordinary skilled in the art to understand the embodiments disclosed herein.

What is claimed is:

1. A key point detection method, comprising:
determining an area in which a plurality of pixels of an image to be processed are located and first direction vectors of the plurality of pixels pointing to a key point of the area, wherein the image to be processed comprises one or more areas; and
determining the position of the key point in the area based on the area in which the pixels are located and the first direction vectors of the plurality of pixels in the area.

2. The method according to claim 1, wherein the determining the position of the key point in the area based on the area in which the pixels are located and the first direction vectors of the plurality of pixels in the area comprises:
determining estimated coordinates of the key point in a target area and weights of the estimated coordinates of the key point based on the area in which the pixels are located and the first direction vectors, wherein the target area is any one of the one or more areas; and
performing weighted averaging on the estimated coordinates of the key point in the target area based on the weights of the estimated coordinates of the key point, to obtain the position of the key point in the target area.

3. The method according to claim 2, wherein the determining the estimated coordinates of the key point in the target area and the weights of the estimated coordinates of the key point based on the area in which the pixels are located and the first direction vectors comprises:
screening the plurality of pixels of the image to be processed based on the area in which the pixels are located, to determine a plurality of target pixels falling within the target area;
determining coordinates of the intersection of the first direction vectors of any two target pixels as the estimated coordinates of the key point; and
determining the weights of the estimated coordinates of the key point based on the estimated coordinates of the key point and the pixels in the target area.

4. The method according to claim 3, wherein the determining the weights of the estimated coordinates of the key point based on the estimated coordinates of the key point and the pixels in the target area comprises:
determining second direction vectors of the plurality of pixels in the target area pointing to the estimated coordinates of the key point respectively based on the estimated coordinates of the key point and coordinates of the plurality of pixels in the target area;
determining inner products of the second direction vectors and the first direction vectors of the plurality of pixels in the target area;
determining a target quantity of pixels with the inner products greater than or equal to a predetermined threshold among the plurality of pixels in the target area; and
determining the weights of the estimated coordinates of the key point based on the target quantity.

5. The method according to claim 1, wherein the determining the area in which the plurality of pixels of the image to be processed are located and the first direction vectors of the plurality of pixels pointing to the key point of the area comprises:
performing feature extraction processing on the image to be processed to obtain a first feature map with a preset resolution;
performing up-sampling processing on the first feature map to obtain a second feature map with the same resolution as the image to be processed; and
performing a first convolution processing on the second feature map to determine the area in which the plurality of pixels are located and the first direction vectors of the plurality of pixels pointing to the key point of the area.

6. The method according to claim 5, wherein the performing feature extraction processing on the image to be processed to obtain the first feature map with the preset resolution comprises:
performing a second convolution processing on the image to be processed to obtain a third feature map with a preset resolution; and
performing dilated convolution processing on the third feature map to obtain the first feature map.

7. The method according to claim 1, wherein the area in which the plurality of pixels of the image to be processed are located and the first direction vectors of the plurality of pixels pointing to the key point of the area are determined via a neural network; the neural network is trained by using a plurality of sample images with partition labels and key point labels.

8. A key point detection apparatus, comprising:
a processor; and
a memory configured to store processor-executable instructions,
wherein the processor is configured to invoke the instructions stored in the memory, so as to:
determine an area in which a plurality of pixels of an image to be processed are located and first direction vectors of the plurality of pixels pointing to the key point of the area, wherein the image to be processed comprises one or more areas; and
determine the position of the key point in the area based on the area in which the pixels are located and the first direction vectors of the plurality of pixels in the area.

9. The apparatus according to claim 8, wherein determining the position of the key point in the area based on the area in which the pixels are located and the first direction vectors of the plurality of pixels in the area comprises:
determining estimated coordinates of the key point in a target area and weights of the estimated coordinates of the key point based on the area in which the pixels are located and the first direction vectors, wherein the target area is any one of the one or more areas; and
performing weighted averaging on the estimated coordinates of the key point in the target area based on the weights of the estimated coordinates of the key point, to obtain the position of the key point in the target area.

10. The apparatus according to claim 9, wherein determining the estimated coordinates of the key point in the target area and the weights of the estimated coordinates of the key point based on the area in which the pixels are located and the first direction vectors comprises:
screening the plurality of pixels of the image to be processed based on the area in which the pixels are located, to determine a plurality of target pixels falling within the target area;
determining coordinates of the intersection of the first direction vectors of any two target pixels as the estimated coordinates of the key point; and
determining the weights of the estimated coordinates of the key point based on the estimated coordinates of the key point and the pixels in the target area.

11. The apparatus according to claim 10, wherein the determining the weights of the estimated coordinates of the key point based on the estimated coordinates of the key point and the pixels in the target area comprises:
determining second direction vectors of the plurality of pixels in the target area pointing to the estimated coordinates of the key point respectively based on the estimated coordinates of the key point and the coordinates of the plurality of pixels in the target area;
determining inner products of the second direction vectors and the first direction vectors of the plurality of pixels in the target area;
determining a target quantity of pixels with the inner products greater than or equal to a predetermined threshold among the plurality of pixels in the target area; and
determine the weights of the estimated coordinates of the key point based on the target quantity.

12. The apparatus according to claim 8, wherein determining the area in which the plurality of pixels of the image to be processed are located and the first direction vectors of the plurality of pixels pointing to the key point of the area comprises:
performing feature extraction processing on the image to be processed to obtain a first feature map with a preset resolution;
performing up-sampling processing on the first feature map to obtain a second feature map with the same resolution as the image to be processed; and
performing a first convolution processing on the second feature map to determine the area in which the plurality of pixels are located and the first direction vectors pointing to the key point.

13. The apparatus according to claim 12, wherein performing feature extraction processing on the image to be processed to obtain the first feature map with the preset resolution comprises:
performing a second convolution processing on the image to be processed to obtain a third feature map with a preset resolution; and
performing dilated convolution processing on the third feature map to obtain the first feature map.

14. The apparatus according to claim 8, wherein the area in which the plurality of pixels of the image to be processed are located and the first direction vectors of the plurality of pixels pointing to the key point of the area are determined via a neural network; the neural network is trained by using a plurality of sample images with partition labels and key point labels.

15. A non-transitory computer-readable storage medium having computer program instructions stored thereon, wherein when the computer program instructions are executed by a processor, the processor is caused to perform the operations of:
determining an area in which a plurality of pixels of an image to be processed are located and first direction vectors of the plurality of pixels pointing to the key point of the area, wherein the image to be processed comprises one or more areas; and
determining the position of the key point in the area based on the area in which the pixels are located and the first direction vectors of the plurality of pixels in the area.
